(19) United States
(12) Patent Application Publication
(10) Pub. No.: US 2026/0260203 A1
(43) Pub. Date: Sep. 3, 2026

(54) DETERMINING REASSIGNMENTS OF DOCKOUT TIMES

(71) Applicant: Walmart Apollo, LLC, Bentonville, AR (US)

(72) Inventors: Darshan Rajesh Chauhan, Dublin, CA (US); Shiv Krishna Jaiswal, Jaunpur (IN); Tiantian Nie, Fremont, CA (US); Fereydoun Adbesh, Rogers, AR (US); Rakesh Manoharan, Fremont, CA (US); Angela Suzanne Pottorff, Chicago, IL (US); Himanshu Prasad, Bentonville, AR (US); Leela Krishna Aravapalli, Tracy, CA (US); Trevor Dougjin Suh, Valencia, CA (US); Saurabh Vishwakarma, Varanasi (IN); Peyush Maini, Bentonville, AR (US); Cong Guo, Danville, CA (US); Ti Zhang, Prosper, TX (US); Ranjith Moola, Fremont, CA (US); Joseph Wayne Hendricks, Bentonville, AR (US); Daniel Charles Morland, Bentonville, AR (US); Mingang Fu, Palo Alto, CA (US)

(73) Assignee: Walmart Apollo, LLC, Bentonville, AR (US)

(21) Appl. No.: 19/067,221

(22) Filed: Feb. 28, 2025

(51) Int. Cl. G06Q 10/0835; G06Q 10/0631

(52) U.S. Cl. CPC G06Q 10/0835; G06Q 10/06314

(57) ABSTRACT

Examples relate to a computer-implemented method or system including a processor that can perform certain operations. The operations can include obtaining inputs comprising dockout windows for routes from a depot, capacity information for the depot, and dockout preferences. The operations also can include determining respective assignment penalties associated with respective assignments for feasible combinations of the routes and time periods within the dockout windows for the routes. The operations additionally can include determining a solution set of the respective assignments that minimize a total penalty. The operations further can include reassigning at least a portion of dockout times in the solution set to spread out the portion of the dockout times at the depot based on the dockout preferences. The operations additionally can include outputting the dockout times, as reassigned, for the routes. Other embodiments are described.

### TECHNICAL FIELD

This disclosure relates generally to determining reassignments of dockout times for outbound transportation.

### BACKGROUND

Transportation logistics operations involve complex scheduling and coordinating the transport of loads along routes. For example, an outbound transportation network can distribute loads from distribution centers to stores. Dockout times refer to when vehicles depart from a distribution center to begin their delivery routes to the stores.

### BRIEF DESCRIPTION OF THE DRAWINGS

To facilitate further description of the embodiments, the following drawings are provided in which:

FIG. 1 illustrates a block diagram of a system that can be employed for optimizing dockout times for outbound transportation, according to an embodiment;

FIG. 2 illustrates a graph depicting time schedules showing dockout time windows for multiple routes at a distribution center;

FIG. 3 illustrates a graph depicting time schedules showing dockout optimization results for the six routes of FIG. 2 when the shift dockout preference is latest departure;

FIG. 4 illustrates a graph depicting time schedules showing dockout optimization results for the six routes of FIG. 2 when the shift dockout preference is earliest departure;

FIG. 5 illustrates a simplified example of an outbound transportation network, which includes a distribution center and stores;

FIG. 6 illustrates a flowchart for a method of determining reassignments of dockout times, according to another embodiment;

FIG. 7 illustrates a front elevational view of a computer system that is suitable for implementing an embodiment of the system disclosed in FIG. 1; and

FIG. 8 illustrates a representative block diagram of an example of the elements included in the circuit boards inside a chassis of the computer system of FIG. 7.

### DETAILED DESCRIPTION

Dockout times represent departure times of a route from a distribution center (distribution) to stores. In conventional approaches to determining dockout times for outbound transportation, several challenges may arise. These challenges can include inefficient use of distribution center capacity, failure to consider store preferences, and inability to balance multiple competing factors simultaneously. Such approaches can lead to suboptimal route scheduling, increased manual interventions, and reduced overall efficiency in the transportation network.

In many embodiments, the systems and methods described herein can provide techniques for optimizing dockout times for outbound transportation that address these challenges. For example, the techniques can reassign the dockout times to spread out the dockout times at the distribution center within allowable dockout windows, while considering capacities and store preferences. The systems and methods can consider various constraints and preferences to determine optimal dockout times for routes departing from a distribution center.

In many embodiments, a dockout window for each route can be obtained, such as through the process described in U.S. Patent Application Publication No. 2024/0403816 (the “'816 Publication”), which is incorporated herein by reference in its entirety. For example, the dockout time window can be based on the sequence of stops in the route at the stores, shift time windows at the distribution center, store time windows at the stores, hours-of-service rules provided by the U.S. Department of Transportation, and/or other suitable factors. In many embodiments, the techniques described herein can determine dockout times based on the operational capacity of the distribution center, and dockout preferences of the depot and/or the stores. For example, in some cases, the techniques can take into account store slack time when determining dockout times. Store slack time can be the amount of time before the latest store arrival time that the store would like to receive delivery. By considering store slack time, the techniques can better align dockout times with store preferences, improving delivery efficiency and reducing manual interventions.

In many embodiments, the techniques can use a two-phase approach to optimize dockout times. In the first phase, a macro-scale route-period assignment can be performed using mixed integer linear programming (MILP). This first phase can consider various factors such as depot capacity, shift preferences, and store preferences to determine an initial assignment of routes to time periods. In the second phase, a heuristic method can be used to determine a reassignment of the dockout times within the assigned time periods. This heuristic method can refine the dockout times to spread them out within the available time windows, reducing congestion at the depot and manual interventions by the depot, and improving overall operational efficiency. By combining the MILP for initial assignment and the heuristic method for fine-tuning, the techniques can balance computational efficiency with the ability to consider complex constraints and preferences. This approach can allow for more effective optimization of dockout times compared to conventional methods that may rely on simpler heuristics or manual adjustments.

The techniques described herein can provide technical improvements in the field of outbound transportation scheduling. These improvements can include more efficient use of depot capacity, better alignment with store preferences, and reduced manual interventions in scheduling. As a result, the overall efficiency and effectiveness of the transportation network can be enhanced.

Various embodiments include a system including a processor and a non-transitory computer-readable medium storing computing instructions that, when executed on the processor, cause the processor to perform certain operations. The operations can include obtaining inputs comprising dockout windows for routes from a depot, capacity information for the depot, and dockout preferences. The operations also can include determining respective assignment penalties associated with respective assignments for feasible combinations of the routes and time periods within the dockout windows for the routes. The operations additionally can include determining a solution set of the respective assignments that minimize a total penalty. The operations further can include reassigning at least a portion of dockout times in the solution set to spread out the portion of the dockout times at the depot based on the dockout preferences. The operations additionally can include outputting the dockout times, as reassigned, for the routes.

A number of embodiments include a computer-implemented method. The method can include obtaining inputs comprising dockout windows for routes from a depot, capacity information for the depot, and dockout preferences. The method also can include determining respective assignment penalties associated with respective assignments for feasible combinations of the routes and time periods within the dockout windows for the routes. The method additionally can include determining a solution set of the respective assignments that minimize a total penalty. Determining the solution set can include using mixed integer linear programming to minimize a sum of a dockout breach penalty and the respective assignment penalties based on constraints. The method further can include reassigning at least a portion of dockout times in the solution set to spread out the portion of the dockout times at the depot based on the dockout preferences. The method additionally can include outputting the dockout times, as reassigned, for the routes.

Additional embodiments include a non-transitory computer-readable medium storing computing instructions that, when executed on a processor, cause the processor to perform certain operations. The operations can include obtaining inputs comprising dockout windows for routes from a depot, capacity information for the depot, and dockout preferences. The operations also can include determining respective assignment penalties associated with respective assignments for feasible combinations of the routes and time periods within the dockout windows for the routes. The operations additionally can include determining a solution set of the respective assignments that minimize a total penalty. The operations further can include reassigning at least a portion of dockout times in the solution set to spread out the portion of the dockout times at the depot based on the dockout preferences. Reassigning at least a portion of dockout times in the solution set can include sub-partitioning the time periods for which there are multiple of the routes assigned in the solution set and greedily assigning routes to a feasible sub-partition based on a maximum average gap between the routes. The operations additionally can include outputting the dockout times, as reassigned, for the routes.

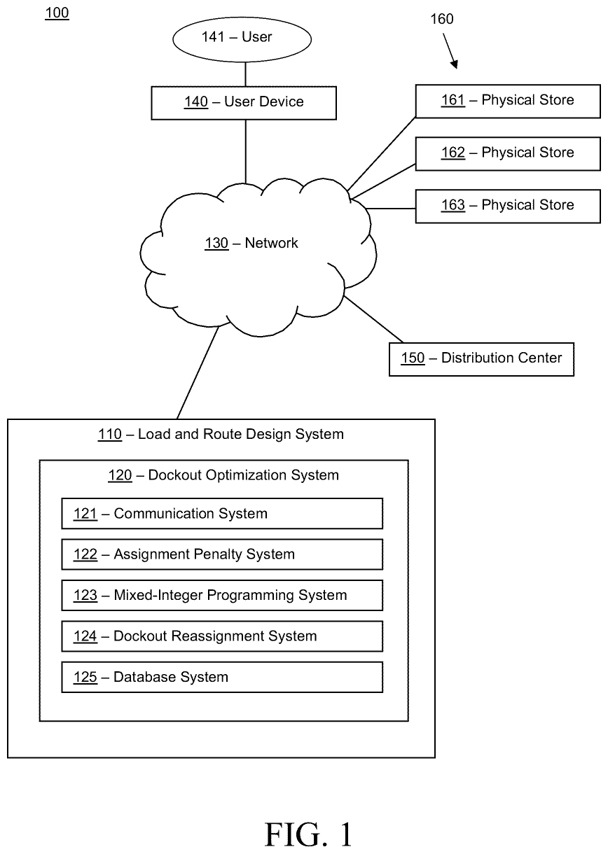

Turning ahead in the drawings, FIG. 1 illustrates a block diagram of a system 100 that can be employed for optimizing dockout times for outbound transportation. System 100 is merely an example, and embodiments of the system are not limited to the embodiments presented herein. The system can be employed in many different embodiments or examples not specifically depicted or described herein. In some embodiments, certain elements, modules, or systems of system 100 can perform various procedures, processes, and/or activities. In other embodiments, the procedures, processes, and/or activities can be performed by other suitable elements, modules, or systems of system 100. In some embodiments, system 100 can include a load and route design system 110 and/or a dockout optimization system 120. Generally, system 100 can be implemented with hardware and/or software, as described herein.

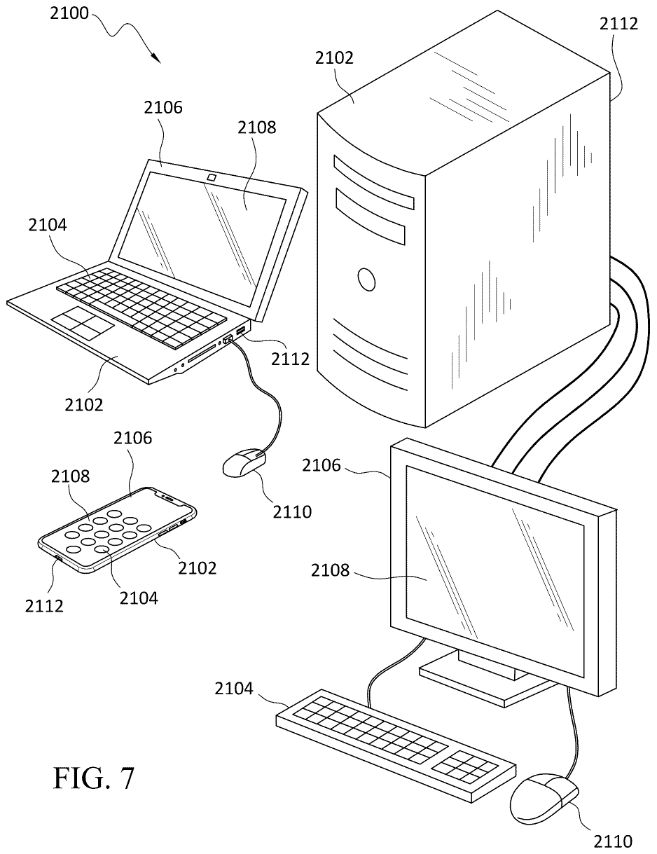

Load and route design system 110 and/or dockout optimization system 120 can each be a computer system, such as computer system 2100 (FIG. 7), as described below, and can each be a single computer, a single server, or a cluster or collection of computers or servers, or a cloud of computers or servers. In another embodiment, a single computer system can host load and route design system 110 and dockout optimization system 120. For example, as shown in FIG. 1, dockout optimization system 120 can be part of load and route design system 110. In many embodiments, load and route design system 110 can be similar to the load and route design system described in the '816 Publication.

In some embodiments, load and route design system 110 and/or a dockout optimization system 120 can be in data communication through a network 130 with physical stores 160, such as physical stores 161-163, and distribution centers, such as a distribution center 150. In several embodiments, each of the physical stores (e.g., 160) and each of the distribution centers (e.g., 150) can be a physical, brick-and-mortar location that is associated (e.g., operated by a common business entity or entities under common control) with load and route design system 110 and/or a dockout optimization system 120. In many embodiments, the physical stores (e.g., 160) and the distribution centers (e.g., 150) each can include one or more computer systems. In a number of embodiments, each of physical stores 160 can be a retail store, such as a department store, a grocery store, or a super store (e.g., both a grocery store and a department store). In many embodiments, the distribution centers (e.g., 150) can provide items to the physical stores (e.g., 160). For example, a distribution center (e.g., 150) can supply and/or replenish stock at the physical stores (e.g., 160) that are in a region of the distribution center. In many embodiments, a physical store (e.g., 161-163) can submit an order to a distribution center (e.g., 150) to supply and/or replenish stock at the physical store (e.g., 161-163).

In some embodiments, load and route design system 110 and/or a dockout optimization system 120 can be a distributed system that includes one or more systems in each of the distribution centers (e.g., 150). In other embodiments, load and route design system 110 and/or a dockout optimization system 120 can be a centralized system that communicates with computer systems in the physical stores (e.g., 160) and distribution centers (e.g., 150). In some embodiments, network 130 can be an internal network that is not open to the public, which can be used for communications between load and route design system 110, dockout optimization system 120, physical stores (e.g., 160), and distribution centers (e.g., 150). In other embodiments, network 130 can be a public network, such as the Internet or another suitable network.

In some embodiments, dockout optimization system 120 can be in data communication through network 130 with one or more user devices, such as a user device 140. User device 140 can be part of system 100 or external to system 100. In some embodiments, user device 140 can be used by transportation routing administrators, such as a user 141. In certain embodiments, the user devices (e.g., user device 140) can be desktop computers, laptop computers, mobile devices, and/or other endpoint devices used by one or more users (e.g., user 141). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. Examples of mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement the iPhone® operating system by Apple Inc. of Cupertino, California, United States of America, the Android™ operating system developed by the Open Handset Alliance, or another suitable operating system.

In many embodiments, load and route design system 110 and/or dockout optimization system 120 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). The input device(s) and the display device(s) can be coupled to load and route design system 110 and/or dockout optimization system 120 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of load and route design system 110 and/or dockout optimization system 120. In a similar manner, the processors and/or the non-transitory computer-readable media can be local and/or remote to each other.

Meanwhile, in many embodiments, load and route design system 110 and/or dockout optimization system 120 also can be configured to communicate with one or more databases, such as a database system 125. The one or more databases can include data related to outbound transportation logistics, such as route information, depot capacities, store preferences, historical delivery data, operational parameters such as shift schedules, travel times between locations, and dockout time windows for different routes and time periods. The one or more databases can be stored on one or more memory storage units (e.g., non-transitory computer readable media), which can be similar or identical to the one or more memory storage units (e.g., non-transitory computer readable media) described with respect to computer system 2100 (FIG. 7). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Examples of database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, load and route design system 110, dockout optimization system 120, and/or the one or more databases can be implemented using any suitable manner of wired and/or wireless communication. Accordingly, system 100 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Examples of PAN protocol(s) can include Bluetooth, Zigbee, Wireless Universal Serial Bus (USB), Z-Wave, etc.; examples of LAN and/or WAN protocol(s) can include Institute of Electrical and Electronic Engineers (IEEE) 802.3 (also known as Ethernet), IEEE 802.11 (also known as Wi-Fi), etc.; and examples of wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, examples of communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further examples of communication hardware can include wireless communication hardware including, for example, one or more radio transceivers, one or more infrared transceivers, etc. Additional examples of communication hardware can include one or more networking components (e.g., modulator-demodulator components, gateway components, etc.).

In several embodiments, load and route design system 110 can receive orders from physical stores (e.g., 161-163) and can automatically design how the orders will be fulfilled from a distribution center (e.g., 150) to delivery at the stores, which can be similar to the load and route design system described in the '816 Publication. In many embodiments, load and route design system 110 can create routes visiting stores from a depot (in most cases, a distribution center (DC)) along with load arrangement in each trailer associated with the route. In general, each route can visit multiple stores before reaching the final destination (usually, the origin depot or an inbound delivery location). Accounting for all the time windows (TWs) of the stops on the route (stores, inbound pickup location, inbound delivery location), load and route design system 110 can determine a departure TW at the depot (i.e., the dockout window). The time when a route departs from the depot is called dockout time. For the optimal solution, the corresponding dockout window is called the optimal dockout window. As a rule, for any dockout time in the optimal dockout window, the route experiences minimum cost as determined by load and route design system 110.

In many embodiments, dockout optimization system 120 can include a communication system 121, an assignment penalty system 122, a mixed-integer programming system 123, a dockout reassignment system 124, and/or database system 125. In many embodiments, the systems of dockout optimization system 120 can be computing instructions (e.g., software components) stored at non-transitory computer readable media that operate on one or more processors. In other embodiments, the systems of dockout optimization system 120 can be implemented in hardware.

In many embodiments, communication system 121 can facilitate data exchange between various components of the load and route design system 110 and other systems, such as distribution center 150 and physical stores 160. Communication system 121 can handle the transmission of route information, depot capacities, store preferences, and optimization results between the assignment penalty system 122, mixed-integer programming system 123, and dockout reassignment system 124. Additionally, communication system 121 can manage real-time data flows in the dockout optimization process.

In many embodiments, assignment penalty system 122 can perform preprocessing steps and generate assignment penalties for route-period combinations. Assignment penalty system 122 can calculate route-level slack time based on the latest arrival times and slack times of individual stops on each route. Assignment penalty system 122 can determine preferred dockout times for routes, either from store-specified preferences or by deriving default values based on operational factors. For each combination of routes and time periods within the dockout windows, assignment penalty system 122 can determine whether the assignment is feasible by checking if the route can be completed within its time window. Assignment penalty system 122 can calculate assignment penalties for feasible assignments based on dockout preferences, considering factors such as shift-related strategies and store-specified preferred times. These assignment penalties can include factors such as deviation from preferred dockout times, impact on depot capacity utilization, and adherence to shift-related preferences. The assignment penalties can be determined for each feasible route-period combination. Assignment penalty system 122 can output the calculated penalties, which serve as inputs for the mixed-integer programming system 123 in optimizing dockout times. Assignment penalty system 122 can scale these penalties to a standardized range, such as −10 to 10, to provide consistent inputs for mixed-integer programming system 123.

In many embodiments, mixed-integer programming system 123 can utilize the assignment penalties and other constraints to determine an optimal solution set for route-period assignments. Mixed-integer programming system 123 can employ advanced optimization algorithms to process the inputs from the assignment penalty system 122, along with depot capacity information and dockout windows, to generate a solution that minimizes the total penalty while satisfying operational constraints. Mixed-integer programming system 123 can handle complex scheduling problems involving multiple routes, time periods, and competing objectives, based on a set of constraints. Mixed-integer programming system 123 can output a solution set that assigns each route to a specific time period, forming the basis for further refinement by the dockout reassignment system 124.

In many embodiments, dockout reassignment system 124 can fine-tune the dockout times within the solution set provided by mixed-integer programming system 123. Dockout reassignment system 124 can employ heuristic algorithms to adjust the specific dockout times within assigned time periods, to spread out departures more evenly while maintaining adherence to operational constraints and preferences. Dockout reassignment system 124 can consider factors such as the maximum average gap between routes and sub-partition time periods with multiple assigned routes. Dockout reassignment system 124 can output the final optimized dockout times for each route, which can then be communicated to the relevant stakeholders through communication system 121.

In many embodiments, these techniques can determine the dockout time within the dockout time window. Various aspects can affect the determination of dockout time. Each route can be associated with a shift, which contains information about dockout strategy (generic and for special route types) among other things. The generic dockout strategy can be earliest (i.e., as early as possible, or, near the start of the optimal dockout window) or latest (i.e., as late as possible, or, near the end of the optimal dockout window). Special route types are routes that fulfill specific criteria. For example, single-stop drop-hook routes can be specified to dockout earliest, and then, routes fulfilling that criteria will dockout earliest even when the generic dockout strategy for its shift are latest.

Each store can support the input of store preferred dockout time and store slack time. Store preferred dockout time is the time the store prefers that the route it is on docks out. A store could have no preference towards dockout time. Store slack time is the amount of time before the latest store arrival time that the store would like to receive delivery. For example, if store has delivery TW of 4 pm to 11 pm, and the store slack time is 1 hour, then the store would like to receive delivery before 10 pm. However, the store would still accept delivery until 11 pm.

Operationally, the depot is capacity constrained. The transportation operations have a dockout capacity constraint regarding the number of routes that can dockout from the depot. DC operations have a constraint on order-filling the pallets onto the trailer. These capacities can vary throughout the planning period. For the execution in dockout optimization system 120, the dockout capacity constraints for the transportation operations can be considered, which can be represented in routes that can be docked out per unit period. The input schema for this depot capacity can include the following fields: capacity type (dockout or order-filling); start time and end time, representing the time period with constant capacity; unit time period representing the minimum time over which the capacity needs to be enforced; and capacity per unit time period of the specified capacity type. The techniques can spread out the dockout time of the routes within a release. The dockout time of each route can be kept within the corresponding optimal dockout window, while adhering to the depot capacity, shift-related dockout preferences, and store-related dockout preferences as much as possible. A two-phase approach can provide macro-scale route-period assignment while considering the criteria for decision-making using a MILP-based approach, followed by a heuristic that determines the dockout time of each route.

In many embodiments, these techniques can optimize dockout times for routes at a distribution center, by distributing these dockout times while adhering to constraints and preferences. These constraints can include optimal dockout windows, depot capacity limitations, shift dockout preferences, and store dockout preferences. The optimization process can spread out the dockout times as much as possible while minimizing violations of these constraints. For each outbound release, the techniques can solve a specific problem with defined inputs, outputs, and objectives. The inputs can include current release information, including details about shifts, stores, configurations, depot capacity, a list of outbound routes, which may or may not include backhaul. Shifts can include information about schedules, such as operational times for trailers and drivers, origins, destinations, delivery types, duration, earliest start time, latest finish time, store times, etc. The output of this optimization process is a list of dockout times for the outbound routes with their dockout times spread out according to the optimization criteria. The techniques can minimize the penalties associated with violating depot capacity, shift dockout preferences, and store dockout preferences. This approach allows for a balanced distribution of dockout times while respecting operational constraints and preferences. For example, a distribution center may have 150 routes that ship out per day for a commodity type (e.g., dry shipment), and if the operators of the distribution center have concerns with proposed dockout times, they can request manual intervention, such as escalating to a command center to change some of the dockout times. These manual interventions are disruptive, so the optimization of dockout times can limit such manual interventions.

Configurable inputs to the dockout optimization system 120 can include modular depot capacity, shift-related dockout preferences, store-related dockout preferences, and/or other suitable configurations. These levers can provide the flexibility and granularity needed to address various operational scenarios and constraints in the transportation network. Modular depot capacity inputs can allow for precise definition of capacity parameters, such as capacity type (such as order filling or dockout), start time and end time to define operational windows, unit dockout time period (UDTP) for time granularity (e.g., 30 minutes, 1 hour), capacity per UDTP (e.g., dockout 2 routes per 30 minutes), and/or other suitable representations of depot capabilities. Shift-related dockout preferences can include generic dockout strategies, such as a depot's preference for earliest or latest departure times, and/or specific strategies for special routes, such as single-stop drop-hook routes. In a single-stop drop-hook route, a trailer goes from the depot to a single store, drops the trailer at the store, and hooks up a loaded trailer at the store, then returns to the depot, which can allow the driver to return faster and can provide the store with more flexibility on when to unload the dropped trailer. Store-related dockout preferences can consider individual store preferences, such as store-preferred dockout times at the depot and/or store slack time. For the store-preferred dockout times at the depot, a store may prefer a certain depot dockout time to allow the store to handle a certain number of deliveries per day. The store slack time can represent the buffer period before the latest acceptable delivery time. For example, if 11 pm is the last delivery time, and the neighborhood has a noise ordinance at 10 pm, the store can request delivery one hour earlier than the last delivery time. These levers can allow dockout optimization system 120 to balance multiple operational constraints and preferences to provide more efficient and satisfactory dockout scheduling across the transportation network.

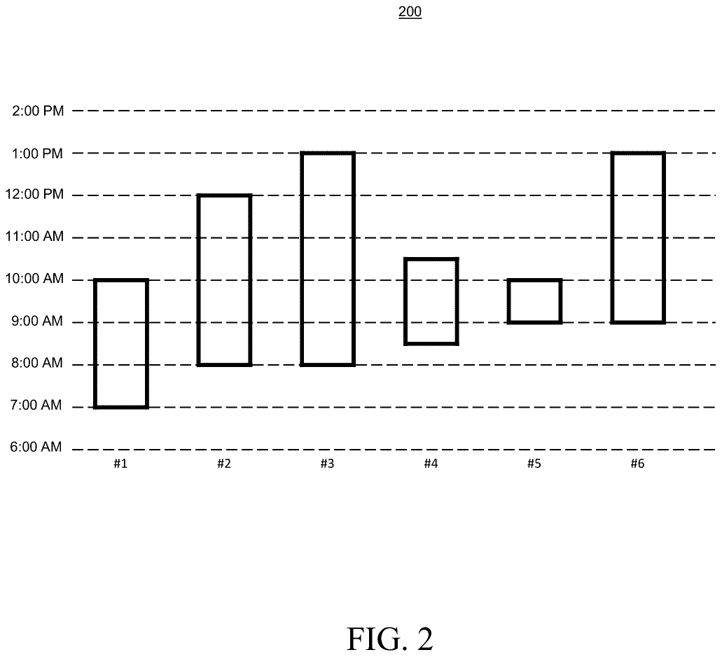

FIG. 2 illustrates a graph depicting time schedules 200 showing dockout time windows for multiple routes at a distribution center. The graph shows six routes (routes #1-6) along the x-axis. The y-axis represents time of day, ranging from 6:00 AM to 2:00 PM. Each dockout time window is represented by a vertical box indicating its allowable dockout time window. The time windows vary in duration, with some routes having longer windows than others. For example, route #1 has a window from approximately 7:00 AM to 10:00 AM, while route #5 shows a shorter window from about 9:00 AM to 10:00 AM.

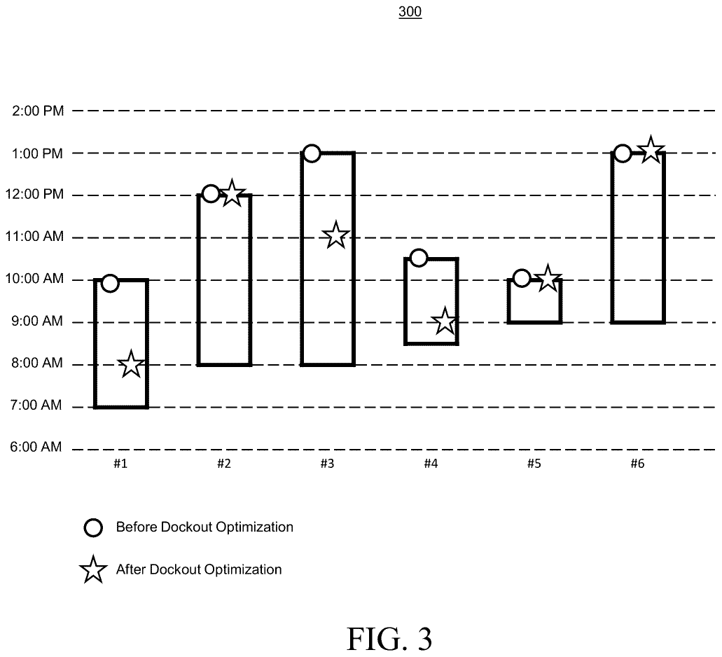

FIG. 3 illustrates a graph depicting time schedules 300 showing dockout optimization results for the six routes of FIG. 2 when the depot capacity is one route per hour, the shift dockout preference is latest departure, and the store dockout preference is none. The dockout time for each route is represented by two markers: a circle indicating the dockout time before optimization, and a star showing the dockout time after optimization. The optimization results vary across routes, with some experiencing significant shifts in dockout times while others show minor adjustments. For example, route #1 shows an adjustment from approximately 10:00 AM before optimization to around 8:00 AM after optimization, while route #4 shows an adjustment from about 10:30 AM to 9:00 AM.

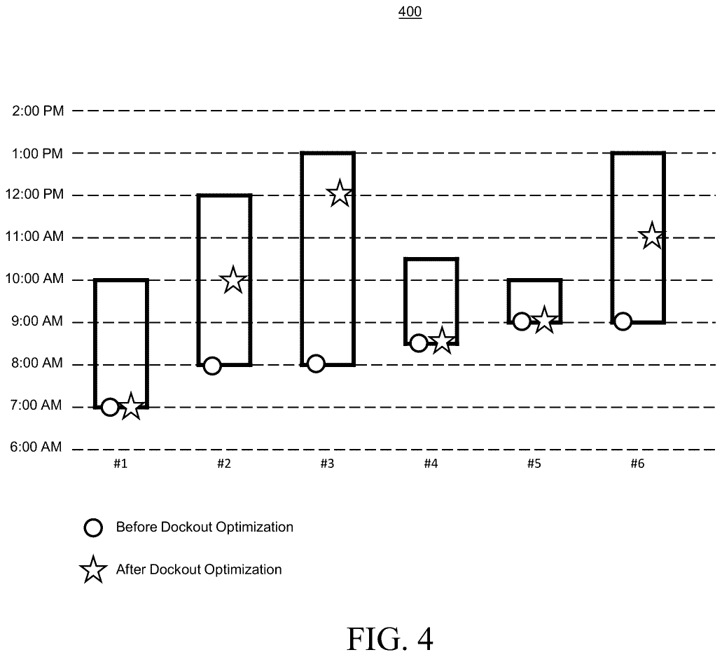

FIG. 4 illustrates a graph depicting time schedules 400 showing dockout optimization results for the six routes of FIG. 2 when the depot capacity is one route per hour, the shift dockout preference is earliest departure, and the store dockout preference is none. The dockout time for each route is represented by two markers: a circle indicating the dockout time before optimization, and a star showing the dockout time after optimization. The optimization results demonstrate how the dockout times are adjusted while respecting each route's time window constraints. For example, route #2 shows an adjustment from approximately 8:00 AM before optimization to around 10:00 AM after optimization, while route #3 shows an adjustment from about 8:00 AM to 12:00 PM.

Returning to FIG. 1, in many embodiments, dockout optimization system 120 can provide a structured approach to modeling and solving the problem of assigning routes to specific time periods. This process can begin with defining the time scale, which is modeled at each UDTP from the earliest start to the latest end as specified in the depot capacity input. The optimization process can include preprocessing performed by assignment penalty system 122, such as calculating the slack time at the route level, determining the preferred dockout time, assessing whether a route can be assigned to each period, and determining the assignment penalty based on shift and store dockout preferences.

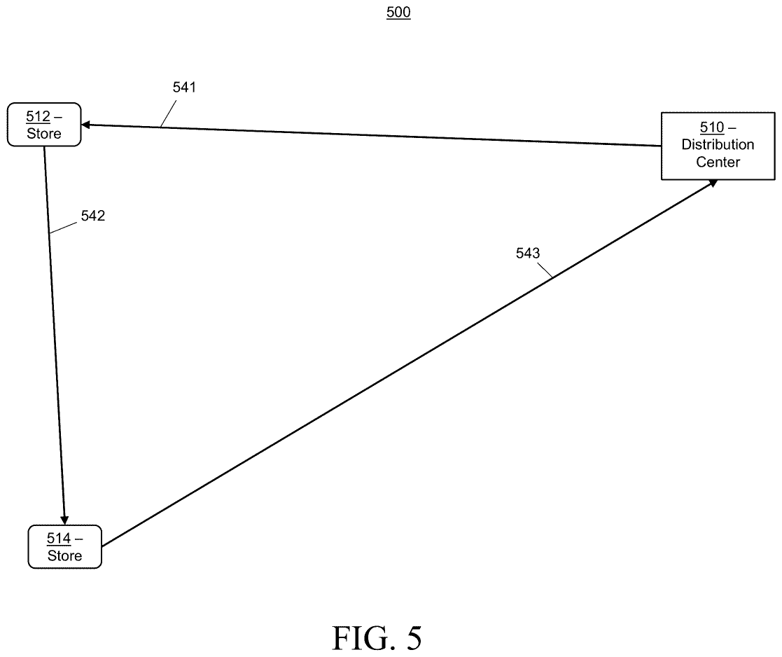

For example, FIG. 5 illustrates a simplified example of an outbound transportation network 500, which includes a distribution center 510 and stores 512 and 514. A route involves traveling from distribution center 510 to store 512 along leg 541, which can take 1 hour of travel time. The service time at store 512 can be 1 hour. Next, the route can include traveling from store 512 to store 514 along leg 542, which can take 1 hour of travel time. The service time at store 514 can be 1 hour. Next, the route can include traveling from store 514 to distribution center 510 along leg 543, which can take 2 hours of travel time. At store 512, then start time from unloading can be 7 am and the end time for unloading can be 1 pm, and the store-level slack time can be 60 minutes, meaning that store 512 prefers to have the end time for unloading by 12 pm. At store 514, the start time for unloading can be 8 am and the end time for unloading can be 2 pm, and the store-level slack time can be 15 minutes, meaning that store 514 prefers to have the end time by 1:45 pm. The route-level slack time can be 15 minutes.

Returning to FIG. 1, the processing performed by assignment penalty system 122, mixed-integer programming system 123, and dockout reassignment system 124, can be described mathematically, using sets, parameters, and variables as follows:

### Core Sets and Indices

[symbol] set of all routes that need to be assigned dockout time, indexed as r∈ [symbol]
[symbol] set of all unit time periods, indexed as tϵ [symbol] :={0, 1, 2, . . . , | [symbol] |−1}

### Auxiliary Sets and Indices

Sᵣ set of all stops on route r∈ [symbol] indexed as s∈Sᵣ
[symbol] set of all shifts, indexed as h∈ [symbol]
[symbol] ordered set of all possible special route types (e.g., single-stop drop-hook) in non-increasing priority, indexed as j∈

[symbol]

### Core Parameters

eᵣ start time of optimal dockout window of route r∈ [symbol] ; eᵣ∈ [symbol]
lᵣ end time of optimal dockout window of route [symbol] ∈ [symbol] ; eᵣ∈ [symbol]
Oᵣ slack time of route r∈ [symbol] ; oᵣ∈[0, lᵣ−eᵣ]
pᵣ preferred dockout time of route r∈ [symbol] ; pᵣ∈ [symbol]
aᵣₜ 1, if route r∈ [symbol] can be assigned to time period t∈ [symbol] , and 0, otherwise
dᵣ dockout strategy of route r∈ [symbol] ; dᵣ∈ {earliest, latest}

$${Q}_{t}^{D}$$

dockout capacity in time period t∈ [symbol] ;

$${Q}_{t}^{D} ∈ {ℤ}^{+} ⋃ \{ 0 \}$$

$${c}_{rt}^{A}$$

cost of assigning route r∈ [symbol] to time period t∈ [symbol] ;

$${c}_{rt}^{A} ∈ \text{?}$$

$${c}_{t}^{B}$$

cost per breach of capacity in time period t∈ [symbol] :

$${c}_{t}^{B} ∈ {ℝ}^{+}$$

c^{M} cost related to maximum capacity breach in any time period; c^{M}∈ [symbol] ⁺

### Auxiliary Parameters

ϵₛᵣ start of arrival time window of stop s∈Sᵣ on route r∈ [symbol] ; ϵₛᵣ∈ [symbol]
ιₛᵣ end of arrival time window of stop s∈S, on route r∈ [symbol] ; ιₛᵣ∈ [symbol]
θₛᵣ slack time of stop s∈Sᵣ on route r∈ [symbol] ; θₛᵣ∈[0, ιₛᵣ−ϵₛᵣ]
ρₛᵣ preferred dockout time of stop s∈Sᵣ on route r∈ [symbol] ; ρₛᵣ∈ [symbol]
αₛᵣ arrival time at stop s∈Sᵣ on route r∈ [symbol] given that route r∈ [symbol] departs at time lᵣ; αₛᵣ∈[ϵₛᵣ, ιₛᵣ]
δₕ generic dockout strategy of shift h∈ [symbol] ; δₕ∈ {earliest, latest}

$${δ}_{jh}^{′}$$

dockout strategy of special route type j∈ [symbol] if it is on shift h∈ [symbol] ;

$${δ}_{jh}^{′} ∈$$

{earliest, latest}
βᵣₕ 1, if route r∈ [symbol] has associated shift h∈ [symbol] , and 0, otherwise
γᵣⱼ 1, if route r∈ [symbol] is of special route type j∈ [symbol] , and 0, otherwise

### Decision Variables

xᵣₜ 1, if route r∈ [symbol] is assigned to time period t∈ [symbol] , and 0, otherwise
zₜ a non-negative real variable representing capacity breach in time period t∈ [symbol]
[symbol] a non-negative real variable representing maximum capacity breach

In the pre-processing performed by assignment penalty system 122, various parameters can be calculated. Not all core parameters are available directly, but they can be derived from auxiliary parameters, which are readily available. The optimal dockout window of each route r∈ [symbol] is known, and therefore, parameters eᵣ and lᵣ are known for them.

The calculation of route-level slack time can be determined. For each stop on route s∈Sᵣ, r∈R the effective slack time required

$${θ}_{sr}^{′} ,$$

is calculated as:

$${θ}_{sr}^{′} := max \{ 0 , {α}_{sr} - ( {l}_{sr} - {θ}_{sr} ) \} .$$

Now, the route-level slack time is given by:

$${O}_{r} := min \{ {l}_{r} - {e}_{r} , max \{ {θ}_{sr}^{′} ∀ s ∈ {S}_{r} \} \} ∀ r ∈ \text{?} \qquad ( 1 )$$

A stop s has a preferred dockout time of Integer.MIN_VALUE to indicate no preference. Let

$${S}_{r}^{′} := \{ s ∈ {S}_{r} : {p}_{sr} > Integer . MIN\_VALUE \}$$

represent the set of stops on route r∈ [symbol] which have a valid preferred dockout time. Additionally, let

$${S}_{r}^{″} := \{ s ∈ {S}_{r}^{′} : {e}_{r} \leq {p}_{sr} \leq {l}_{r} \}$$

represent the set of stops whose preferred dockout time is within the optimal dockout window of route r∈ [symbol] . Based on the above definitions the following is always true:

$${S}_{r}^{″} ⊆ {S}_{r}^{′} ⊆ {S}_{r} .$$

Now, the preferred dockout time at the route level can be calculated as:

$${p}_{r} := \{ \begin{matrix}Integer \cdot MIN\_VALUE & if {S}_{r}^{″} = ϕ \\ min \{ {p}_{r} : s ∈ {S}_{r}^{″} \} & if {S}_{r}^{″} , {S}_{r}^{′} \neq ϕ \\ {l}_{r} & if {S}_{r}^{′} \neq ϕ , {S}_{r}^{″} = \\ & ϕ , min \{ {p}_{sr} : s ∈ {S}_{r}^{′} \} > {l}_{r} \\ {e}_{r} & otherwise , i . e . , {S}_{r}^{′} \neq ϕ , {S}_{r}^{″} = \\ & ϕ , min \{ {p}_{sr} : s ∈ {S}_{r}^{′} \} < {e}_{r}\end{matrix} ∀ r ∈ \text{?} \qquad ( 2 )$$

where, φ represents a null set.

Let the interval covered by time period t∈ [symbol] be represented by

$$[ {\text{?}}_{t}^{e} , {\text{?}}_{t}^{l} ) .$$

By default, complete information about capacity is available and, therefore, time is continuous and the following holds true:

$${\text{?}}_{t}^{e} = {\text{?}}_{t - 1}^{l} ∀ t ∈ \text{?} \backslash \{ 0 \} .$$

Now, the route-period assignment feasibility parameter is given as:

$${a}_{rt} := \{ \begin{matrix}1 & if {𝒯}_{t}^{e} \leq {l}_{r} , {𝒯}_{t}^{l} > {e}_{r} , {p}_{r} = Integer \cdot MIN\_VALUE \\ 1 & if {𝒯}_{t}^{e} \leq {p}_{r} < {𝒯}_{t}^{l} , {p}_{r} > Integer \cdot MIN\_VALUE \\ 0 & otherwise\end{matrix} ∀ r ∈ , t ∈ \text{?} \qquad ( 3 )$$

From the above equation (3), it can be noted that the routes with preferred dockout times are considered to be feasible only for one time period. This is to ensure that the preferred dockout time for those routes can be feasibly assigned in the post-process.

As a general rule of thumb, each route is associated with one and only one shift h∈ [symbol] (i.e., [symbol] βᵣₕ=1∀r∈R) but may be qualified to be of multiple special route types (specified by ordered set [symbol] ). Let

$${h}_{r}^{′}$$

be the shift associated with route r∈ [symbol] . Let [symbol] ′:={r∈ [symbol] ′:= [symbol] γᵣⱼ>0} be the set of routes this is of at least one special route type. For a route r∈ [symbol] ′, let

$${j}_{r}^{′}$$

be the first index while traversing the ordered set [symbol] such that βᵣⱼ=1. Then, the dockout strategy at a route level is determined as follows:

$${d}_{r} := \{ \begin{matrix}{δ}_{{h}_{r}^{′}} & if r ∈ \text{?} \backslash {\text{?}}^{′} \\ {δ}_{{j}_{r}^{′} {h}_{r}^{′}}^{′} & if r ∈ \text{?}\end{matrix} ∀ r ∈ \text{?} \qquad ( 4 )$$

Note that the ideal dockout time for a route r∈ [symbol] , in a constraint-free environment, with earliest departure strategy is eᵣ (i.e., the earliest dockout time), and with the latest departure strategy is lᵣ−oᵣ (i.e., the latest slack-time-compliant dockout time). This consideration influences the design of assignment penalty.

The calculation of assignment penalty cost takes into account dockout strategy preferences as well as slack time preferences. The intermediate route-period assignment cost penalty,

$${\hat{c}}_{rt}^{A} ,$$

is calculated as:

$${\hat{c}}_{rt}^{A} := \{ \begin{matrix}0 & if {a}_{rt} = 0 \\ 100 \cdot \frac{( {l}_{r} - {o}_{r} ) - {𝒯}_{t}^{e}}{max \{ {10}^{- 5} , ( {l}_{r} - {o}_{r} ) - {e}_{r} \}} & if {𝒯}_{t}^{l} \leq ( {l}_{r} - {o}_{r} ) , {d}_{r} = latest \\ - 100 \cdot \frac{( {l}_{r} - {o}_{r} ) - {𝒯}_{t}^{e}}{max \{ {10}^{- 5} , ( {l}_{r} - {o}_{r} ) - {e}_{r} \}} & if {𝒯}_{t}^{l} \leq ( {l}_{r} - {o}_{r} ) , {d}_{r} = earliest \\ 0 & if {𝒯}_{t}^{e} \leq {l}_{r} - {o}_{r} < {𝒯}_{t}^{l} \\ 1000 \cdot \frac{{𝒯}_{t}^{e} - ( {l}_{r} - o )}{max \{ {10}^{- 5} , {o}_{r} \}} & otherwise\end{matrix} ∀ r ∈ \text{?} , t ∈ \text{?} \qquad ( 5 )$$

Once the calculation presented in the equation (5) is complete, the costs are scaled in the range of [−10,10], to achieve the final route-period assignment penalty as:

$${c}_{rt}^{A} := 10 \cdot \frac{{\hat{c}}_{rt}^{A}}{max \{ \vert {\hat{c}}_{rt}^{A} \vert , ∀ r ∈ ℛ , t ∈ 𝒯 \}} ∀ r ∈ \text{?} , t ∈ \text{?} \qquad ( 6 )$$

where, |⋅| represents the absolute value function.

Given the large scale of operation, a maximum of 200 routes per release can be expected. A business constraint can be to keep the max breach as low as possible. For example, it can be preferred to have capacity breached by 1 route in 5 time periods than to have capacity breached by 2 routes in 1 time period. Additionally, a similar relationship exists in the breach cost per period and the route-period assignment penalty cost, wherein it is acceptable to violate all dockout strategy and slack time preferences in order to not breach dockout capacity in any way. Taking that into consideration, finally, the cost per breach of dockout capacity in each time period,

$${c}_{t}^{B} ,$$

and the maximum breach cost, c^{M}, are given as:

$${c}_{t}^{B} := 10 \cdot 200 = 2000 ∀ t ∈ T \qquad ( 7 )$$

$${c}^{M} := 10 \cdot 200 \cdot 200 = 400000 \qquad ( 8 )$$

Following the preprocessing, the MILP formulation can be solved using mixed-integer programming system 123. The objective of the dockout optimization MILP formulation is to minimize the sum of all penalty costs, which is given as:

$${min}_{r , t} \text{?} {c}_{rt}^{A} {x}_{rt} + {\sum }_{t ∈ 𝒯} {c}_{t}^{B} {z}_{t} + {c}^{m} ω \qquad ( 9 )$$

The first set of constraints are related to the feasible time-period assignment to each route in the release. Equation (10) ensures that routes are assigned only to their corresponding feasible time periods, and equation (11) enforces that each route is assigned only to a single time period.

$${x}_{rt} \leq {a}_{rt} ∀ r ∈ \text{?} , τ ∈ \text{?} \qquad ( 10 )$$

$${\sum }_{t ∈ 𝒯} {x}_{rt} = 1 ∀ r ∈ ℛ \qquad ( 11 )$$

The second set of constraints are dockout capacity conservation constraints taking into account possibility of breaches in capacity and are represented in equation (12).

$$\text{?} {x}_{rt} - {z}_{t} \leq {Q}_{t}^{D} ∀ τ ∈ \text{?} \qquad ( 12 )$$

The third set of constraints are related to the calculation of maximum breach in the model, given by equation (13).

$$ω \geq {z}_{t} ∀ τ ∈ \text{?} \qquad ( 13 )$$

Finally, equations (14)-(16) represent the variable domain restrictions.

$${x}_{rt} ∈ \{ 0 , 1 \} ∀ r ∈ \text{?} , τ ∈ \text{?} \qquad ( 14 )$$

$${z}_{t} \geq 0 ∀ τ ∈ \text{?} \qquad ( 15 )$$

$$ω \geq 0 \qquad ( 16 )$$

Dockout reassignment system 124 can perform post-processing to refine the initial MILP solution to determine route dockout times, considering the dockout strategy and route-level preferred dockout times, to provide that the final schedule aligns with operational preferences and constraints. When multiple routes are assigned to a single period, dockout reassignment system 124 can use a heuristic method to spread dockout times, such as to distribute dockout times more evenly. To achieve this distribution, dockout reassignment system 124 can sub-partitions each period based on route preferred dockout times, then greedily assigns routes to feasible sub-partitions, aiming to maximize the “average gap between routes.” Within each sub-partition, routes can be heuristically spread to further optimize the schedule. This approach can allow for fine-tuning of the dockout times while maintaining the overall structure determined by the MILP solution.

Let

$${x}_{rt}^{*}$$

represent the optimal route to time period assignment obtained by solving the MILP formulation using mixed-integer programming system 123, described above. In this post-processing done by dockout reassignment system 124, the objective is to determine the exact dockout time,

$${x}_{r}^{*}$$

of each route r∈ [symbol] .

The time period,

$${t}_{r}^{*} ,$$

in which route r∈ [symbol] departs from depot is the one where

$${x}_{{rt}_{t}^{*}}^{*} = 1.$$

From the pre-process of assignment penalty system 122, each time period τ∈ [symbol] is representative of the time interval

$$[ {T}_{t}^{e} , {T}_{t}^{l} ) ,$$

and because of continuous time periods, the following always hold true:

$$[ {T}_{t}^{e} , = {T}_{t - 1}^{3} ∀ τ ∈ \text{?} \{ 0 \} .$$

Considering time to be discrete at the seconds level, the time interval of time period τ∈ [symbol] can be re-represented as

$$[ {T}_{t}^{e} , {T}_{t}^{l} - 1 ] .$$

Let

$${R}_{t}^{″} := \{ r ∈ \text{?} : {x}_{r}^{*} = 1 \}$$

represent the set of routes that are decided to be docked out in time period τ∈ [symbol] . Then, the feasible time interval, fᵣₜ in which route

$$r ∈ {\text{?}}_{t}^{″}$$

can feasibly depart from the origin location is:

$${f}_{rt} = [ \text{?} , {\overline{f}}_{rt} ] = [ max ( {T}_{r}^{e} , {e}_{r} \} , min \{ {T}_{t}^{l} - 1 , {l}_{r} \} ] \qquad ( 17 )$$

$$∀ r = {R}_{t}^{″} , u ∈ \text{?}$$

Let [symbol] ^{p}:={r∈ [symbol] : pᵣ≥Integer, MAX_VALUE} represent routes with a valid preferred dockout time. From the pre-process of assignment penalty system 122, there is only one feasible time period for routes with preferred dockout times, and that is the one which contains it (see equation (3)). As preferred dockout times need to be enforced, the dockout time of routes with the preferred dockout times are:

$${x}_{r}^{*} = {p}_{r} ∀ r ∈ {ℛ}^{p} \qquad ( 18 )$$

Now, for each time interval τ∈ [symbol] , let the routes with fixed dockout times (i.e., the routes having valid preferred dockout time) be defined by the set

$${\text{?}}_{t}^{p} := {\text{?}}^{p} ⋂ {\text{?}}_{t}^{″} .$$

These routes, with fixed dockout times, are considered as anchor points to divide the time interval

$$[ {T}_{t}^{e} , {T}_{t}^{l} - 1 ]$$

into sub-intervals. Note that, in each time period τ∈ [symbol] , there will be

$$\vert {\text{?}}_{t}^{p} \vert + 1$$

sub-intervals. Let Uₜ (indexed as u∈Uₜ) be the set of sub-intervals in the time period τ∈ [symbol] , where

$$\vert {U}_{t} \vert = \vert {\text{?}}_{t}^{p} \vert + 1. Let [ {v}_{u}^{e} , {v}_{u}^{l} - 1 ]$$

be time interval represented by sub-interval u∈Uₜ. Now, the feasible time sub-interval,

$${f}_{ru}^{′}$$

in which route r∈

$${R}_{t}^{″}$$

can feasibly depart from the origin location is:

$${f}_{ru}^{′} = [ \text{?} , {\overline{f}}_{rt}^{′} ] = [ max ( {v}_{r}^{e} , {e}_{r} \} , min \{ {v}_{t}^{l} - 1 , {l}_{r} \} ] \qquad ( 19 )$$

$$∀ r ∈ {R}_{t}^{″} , u ∈ {U}_{t} , τ ∈ \text{?}$$

For the remainder of the routes r∈

$${R}_{t}^{p} ∖ {R}_{t}^{″} ,$$

the objective is to spread them out in the time period τ∈ [symbol] as much as possible. For that, the first step is determining which sub-interval in the time period τ∈ [symbol] will these routes be assigned to. To achieve this, in a random order, the routes r∈

$${R}_{t}^{p} ∖ {R}_{t}^{″} ,$$

are assigned one-by-one to the sub-interval with the largest average gap (described by equation (20)) for which feasible assignment is possible (determined by overlap the route feasible assignment interval (equation (17)) and the sub-interval u∈Uₜ).

$$avg\_subinterval {\_gap}_{u} = \frac{length\_of {\_subinterval}_{u}}{num\_routes \_in {\_subinterval}_{u} + 1} \qquad ( 20 )$$

$$∀ u ∈ {U}_{t}$$

Finally, let

$${R}_{u}^{′′′}$$

be the set of routes from

$${R}_{t}^{p} ∖ {R}_{t}^{″}$$

that are assigned to the sub-interval u∈Uₜ. The routes in this set are sorted by their earliest valid start time and valid end time (equation (19)), and then by their dockout strategy (earliest first, latest second). Let

$${R}_{u}^{′′′}$$

also reflect this sorted order of routes. Also, let arg(r) represent the argument index of route r∈

$${R}_{u}^{′′′} .$$

Now, the dockout times of the routes in the subinterval u∈Uₜ of time period τ∈ [symbol] are given by traversing the set

$${R}_{u}^{′′′} :$$

$${x}_{r}^{*} = \{ \begin{matrix}{f}_{ru}^{′} & if arg ( r ) = 0 \\ min \{ max \{ {x}_{r - 1}^{*} + {Δ}_{ru} , {f}_{ru}^{′} \} , {\overline{f}}_{ru}^{′} & otherwise\end{matrix} ∀ r ∈ {R}_{u}^{′′′} \qquad ( 21 )$$

where,

$${x}_{r - 1}^{*}$$

is the dockout time of route at the argument index (arg(r)=1) in the set

$${R}_{u}^{′′′}$$

and

$${Δ}_{r u} = \frac{( {v}_{u}^{l} - 1 ) - {x}_{r - 1}^{*}}{\vert {R}_{u}^{′′′} \vert - arg ( r ) + 1} \qquad ( 22 )$$

Equations (18), (21), (22) combined describe the determination of final dockout time chosen by the designed dockout optimization system.

The complexity of the problem can be significant, with an average release to a distribution center involving approximately 150 routes and 100 periods, resulting in the solution of around 15,000 variables. This level of complexity cannot be performed mentally or with conventional computing approaches. The efficient algorithms and heuristics provided by the techniques described herein provide a technical improvement of improving the algorithmic approach to provide practical and effective dockout schedules within reasonable computational time. In many embodiments, these techniques can beneficially offer significant advantages in terms of modularity and efficiency. The modular design can allow users to selectively utilize specific functionalities based on their operational needs, providing flexibility in the application of the system across various scenarios. For example, users can achieve route spread-out near their departure strategy in the face of very high capacity, allowing for focused optimization without strict capacity constraints. As another example, the selective adjustment of store dockout times to earlier or later periods can be done without compromising overall routing efficiency, accomplished through using store-specific preferred dockout times. In terms of computational efficiency, the system demonstrates significant performance improvements, typically solving optimization problems for each release within a couple of minutes. Before implementing these techniques, manual interventions from distribution centers were related to dockout times in most cases. After implementing these techniques, manual interventions related to dockout times decreased by 85%-100%.

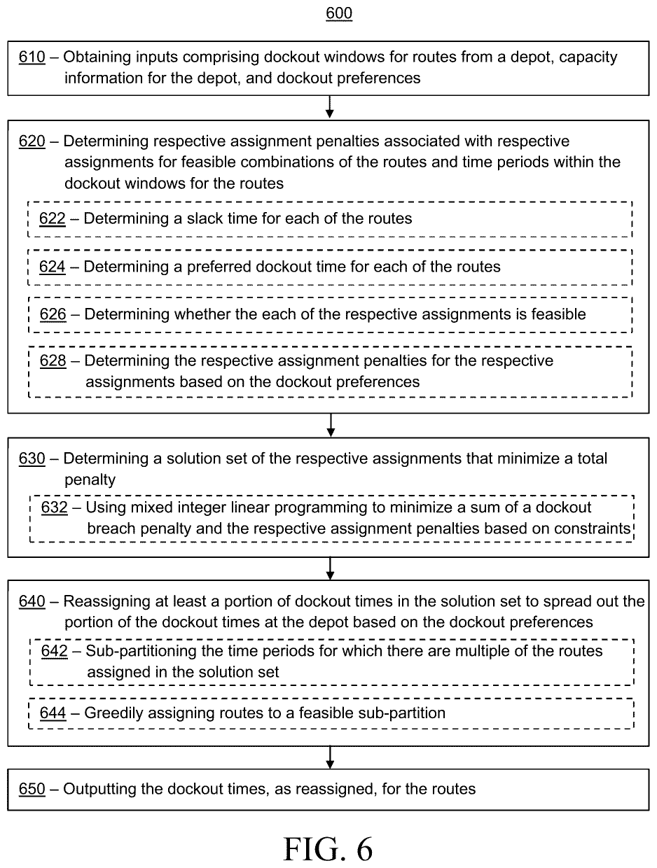

Turning ahead in the drawings, FIG. 6 illustrates a flowchart for a method 600 of determining reassignments of dockout times, according to another embodiment. Method 600 is merely an example, and the method is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

In many embodiments, system 100 (FIG. 1), load and route design system 110 (FIG. 1), and/or dockout optimization system 120 (FIG. 1) can be suitable to perform method 600 and/or one or more of the activities of method 600. In these or other embodiments, one or more of the activities of method 600 can be implemented as one or more computing instructions configured to run at one or more processors and configured to be stored at one or more non-transitory computer readable media. Such non-transitory computer readable media can be part of system 100 (FIG. 1). The processor(s) can be similar or identical to the processor(s) described below with respect to computer system 2100 (FIG. 1). In some embodiments, method 600 and other activities in method 600 can include using a distributed network including distributed memory architecture to perform the associated activity. This distributed architecture can reduce the impact on the network and system resources to reduce congestion in bottlenecks while still allowing data to be accessible from a central location.

Referring to FIG. 6, method 600 can include an activity 610 of obtaining inputs comprising dockout windows for routes from a depot, capacity information for the depot, and dockout preferences. In many embodiments, these inputs can be obtained from various sources such as load and route design system 110, database system 125, distribution center 150 (FIG. 1), physical stores 160 (FIG. 1), and/or user device 140 (FIG. 1). The inputs can include data similar to that visualized in FIG. 2. In many embodiments, the dockout preferences can include shift-related dockout preferences and store-specified preferred dockout times. In a number of embodiments, the shift-related dockout preferences can include general dockout strategy and dockout strategy for special route types. In several embodiments, the special route types can include single-stop drop-hook routes. In many embodiments, activity 610 can be performed by communication system 121 (FIG. 1) and/or dockout optimization system 120 (FIG. 1).

In many embodiments, method 600 also can include an activity 620 of determining respective assignment penalties associated with respective assignments for feasible combinations of the routes and time periods within the dockout windows for the routes. In many embodiments, activity 620 can be performed by assignment penalty system 122 (FIG. 1), such as described above.

In some embodiments, activity 620 can include an activity 622 of determining a slack time for each of the routes. The slack time can be calculated based on the latest arrival times and slack times of individual stops on the route.

In some embodiments, activity 620 also can include an activity 624 of determining a preferred dockout time for each of the routes. The preferred dockout time can be based on generic dockout strategy for the distribution center and/or store-specified preferences.

In some embodiments, activity 620 additionally can include an activity 626 of determining whether each of the respective assignments is feasible. Activity 626 can involve checking if the route can be completed within its time window when starting at a given time period.

In some embodiments, activity 620 further can include an activity 628 of determining the respective assignment penalties for the respective assignments based on the dockout preferences. The assignment penalties can be calculated, as described above, and can take into account factors such as deviation from preferred dockout times and adherence to shift-related preferences.

In many embodiments, method 600 additionally can include an activity 630 of determining a solution set of the respective assignments that minimize a total penalty. In many embodiments, activity 630 can be performed by mixed-integer programming system 123 (FIG. 1), such as described above.

In many embodiments, activity 630 can include an activity 632 of using mixed integer linear programming to minimize a sum of a dockout breach penalty and the respective assignment penalties based on constraints. In some embodiments, the constraints can include assigning each of the routes to a single feasible time period of the time periods, preventing breaches in capacity from exceeding a maximum breach, and/or other suitable constraints, such as described above.

In many embodiments, method 600 further can include an activity 640 of reassigning at least a portion of dockout times in the solution set to spread out the portion of the dockout times at the depot based on the dockout preferences. In many embodiments, activity 640 can be performed by dockout reassignment system 124 (FIG. 1), such as described above.

In some embodiments, activity 640 can include an activity 642 of sub-partitioning the time periods for which there are multiple of the routes assigned in the solution set, such as described above.

In some embodiments, activity 640 also can include an activity 644 of greedily assigning routes to a feasible sub-partition based on a maximum average gap between the routes, such as described above. In many embodiments, the routes can be heuristically spread in the sub-partition.

In many embodiments, method 600 additionally can include an activity 650 of outputting the dockout times, as reassigned, for the routes. In many embodiments, the optimized dockout times can be transmitted for display to the user 141 (FIG. 1) on the user device 140 (FIG. 1), allowing for review or implementation of the optimized schedule. In many embodiments, activity 650 can be performed by communication system 121 (FIG. 1) and/or dockout optimization system 120 (FIG. 1). In a number of embodiments, activity 650 of outputting the dockout times can cause the distribution center to transport the shipments from the distribution center to the stores on the route according to the dockout times, as reassigned.

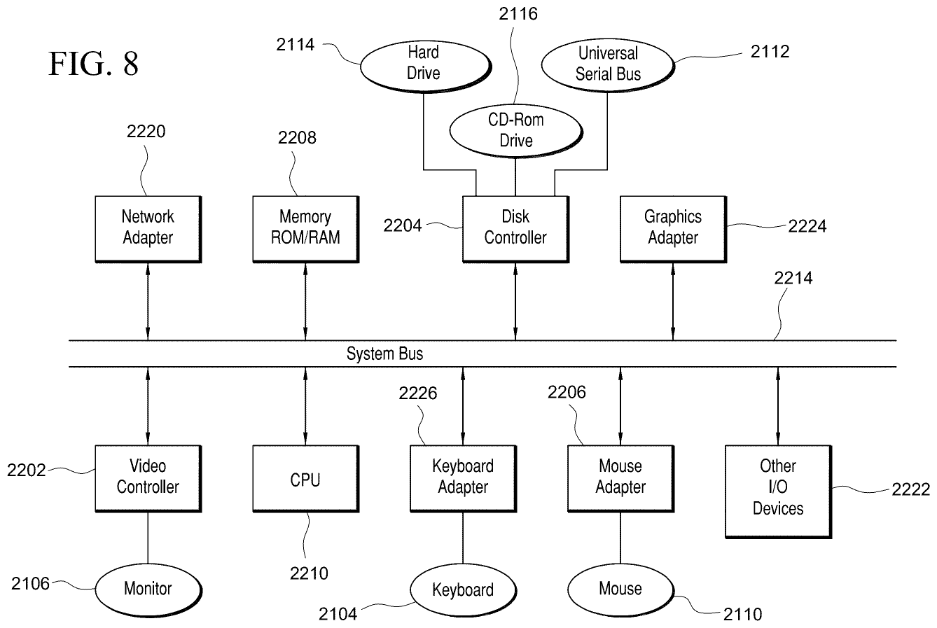

Turning ahead in the drawings, FIG. 7 illustrates an embodiment of three different types (e.g., a tower server, a laptop, and a smart phone) of a computer system 2100. FIG. 8 illustrates a representative block diagram of elements included on the circuit boards inside a chassis 2102 of computer system 2100. All or a port of computer system 2100 can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 2100 (and its internal components, or one or more elements of computer system 2100) can be suitable for implementing part or all of the techniques described herein. Computer system 2100 can comprise chassis 2102 containing one or more circuit boards (not shown) and one or more of an input/output port 2112 (e.g., one or more Universal Serial Bus (USB) ports of one or more types (e.g., USB type-A, type-B, type-C, micro-A, micro-B, mini-A, mini-B, etc.), one or more High-Definition Multimedia interface (HDMI) ports, etc.).

A central processing unit (CPU) 2210 is coupled to a system bus 2214. In various embodiments, the architecture of CPU 2210 can be compliant with any of a variety of commercially distributed architecture families. System bus 2214 also can be coupled to memory storage unit 2208 that includes both read only memory (ROM) and random-access memory (RAM). Non-volatile portions of memory storage unit 2208 or the ROM can be encoded with a boot code sequence suitable for restoring computer system 2100 to a functional state after a system reset. In addition, memory storage unit 2208 can include microcode such as a Basic Input-Output System (BIOS). In some examples, the one or more memory storage units of the various embodiments disclosed herein can include memory storage unit 2208, a USB-equipped electronic device (e.g., an external memory storage unit (not shown) coupled to input/output port 2112), hard drive 2114, and/or one or more CD-ROM, DVD, Blu-Ray, or other suitable media, such as media configured to be used in CD-ROM and/or DVD drive 2116 inside chassis 2102 or in a detachable driver coupled to input/output port 2112.

Non-volatile or non-transitory memory storage unit(s) refer to the portions of the memory storage unit(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Example operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further examples of operating systems can comprise one of the following: (i) the iOS® operating system by Apple Inc. of Cupertino, California, United States of America, or (ii) the Android™ operating system developed by Google, of Mountain View, California, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 2210.

Various I/O devices such as a disk controller 2204, a graphics adapter 2224, a video controller 2202, a keyboard adapter 2226, a mouse adapter 2206, a network adapter 2220, and other I/O devices 2222 can be coupled to system bus 2214. Keyboard adapter 2226 and mouse adapter 2206 can be coupled to a keyboard 2104 and a mouse 2110, respectively, of computer system 2100. While graphics adapter 2224 and video controller 2202 are shown as distinct units, video controller 2202 can be integrated into graphics adapter 2224, or vice versa in other embodiments. Video controller 2202 is suitable for refreshing a monitor 2106 to display images on a screen 2108 of computer system 2100. Disk controller 2204 can control hard drive 2114, input/output port 2112, and CD-ROM and/or DVD drive 2116. In other embodiments, distinct units can be used to control each of these devices separately.

In some embodiments, network adapter 2220 can comprise and/or be implemented as a WNIC (wireless network interface controller) card (not shown) plugged or coupled to an expansion port (not shown) in computer system 2100. In other embodiments, the WNIC card can be a wireless network card built into computer system 2100. A wireless network adapter can be built into computer system 2100 by having wireless communication capabilities integrated into the motherboard chipset (not shown), and/or implemented via one or more dedicated wireless communication chips (not shown), connected through a PCI (peripheral component interconnector) or a PCI express bus of computer system 2100 or input/output port 2112. In other embodiments, network adapter 2220 can comprise and/or be implemented as a wired network interface controller card (not shown).

Although many other components of computer system 2100 are not shown, such components and their interconnection are well known to those of ordinary skill in the art. Accordingly, further details concerning the construction and composition of computer system 2100 and the circuit boards inside chassis 2102 are not discussed herein.

When computer system 2100 is running, program instructions stored on a USB drive in input/output port 2112, on a CD-ROM or DVD in CD-ROM and/or DVD drive 2116 or in the detachable CD-ROM and/or DVD drive coupled to input/output port 2112, on hard drive 2114, or in memory storage unit 2208 are executed by CPU 2210. A portion of the program instructions, stored on these devices, can be suitable for carrying out all or at least part of the techniques described herein. In various embodiments, computer system 2100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components can reside at various times in different storage components of computer system 2100, and can be executed by CPU 2210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 2100 is illustrated as a laptop computer, tower server, and smartphone, there can be examples where computer system 2100 can take a different form factor while still having functional elements similar to those described for computer system 2100. In some embodiments, computer system 2100 can comprise a single computer, a single server, or a cluster or collection of computers or servers, or a cloud of computers or servers. Typically, a cluster or collection of servers can be used when the demand on computer system 2100 exceeds the reasonable capability of a single server or computer. In certain embodiments, computer system 2100 may comprise a portable computer, such as a laptop computer. In certain other embodiments, computer system 2100 can comprise a mobile device, such as a smartphone, smart glasses, smart rings, wearable, virtual reality headset, augmented reality glasses, etc. In certain additional embodiments, computer system 2100 can comprise an embedded system.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although determining reassignments of dockout times has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 can be modified, and that the foregoing discussion of certain of these embodiments does not necessarily represent a complete description of all possible embodiments. For example, one or more of the procedures, processes, or activities of FIG. 6 can include different procedures, processes, and/or activities and be performed by many different modules, in many different orders. As another example, the elements within system 100 (FIG. 1) can be interchanged or otherwise modified.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.05 second, 0.1 second, 0.02 second, 0.5 second, one second, two seconds, five seconds, or ten seconds.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor a non-transitory computer-readable medium storing computing instructions that, when executed on the processor, cause the processor to perform operations comprising:
obtaining inputs comprising dockout windows for routes from a depot, capacity information for the depot, and dockout preferences;
determining respective assignment penalties associated with respective assignments for feasible combinations of the routes and time periods within the dockout windows for the routes;
determining a solution set of the respective assignments that minimize a total penalty;
reassigning at least a portion of dockout times in the solution set to spread out the portion of the dockout times at the depot based on the dockout preferences; and
outputting the dockout times, as reassigned, for the routes.

2. The system of claim 1, wherein determining the respective assignment penalties further comprises:
determining a slack time for each of the routes;
determining a preferred dockout time for each of the routes;
determining whether the each of the respective assignments is feasible; and
determining the respective assignment penalties for the respective assignments based on the dockout preferences.

3. The system of claim 1, wherein the dockout preferences comprise shift-related dockout preferences and store-specified preferred dockout times.

4. The system of claim 3, wherein the shift-related dockout preferences comprise general dockout strategy and dockout strategy for special route types.

5. The system of claim 4, wherein the special route types comprise single-stop drop-hook routes.

6. The system of claim 1, wherein determining the solution set further comprises:
using mixed integer linear programming to minimize a sum of a dockout breach penalty and the respective assignment penalties based on constraints.

7. The system of claim 6, wherein the constraints comprise:
assigning each of the routes to a single feasible time period of the time periods; and
preventing breaches in capacity from exceeding a maximum breach.

8. The system of claim 6, wherein reassigning at least the portion of the dockout times further comprises:
sub-partitioning the time periods for which there are multiple of the routes assigned in the solution set; and
greedily assigning routes to a feasible sub-partition based on a maximum average gap between the routes.

9. A computer-implemented method comprising:
obtaining inputs comprising dockout windows for routes from a depot, capacity information for the depot, and dockout preferences;
determining respective assignment penalties associated with respective assignments for feasible combinations of the routes and time periods within the dockout windows for the routes;
determining a solution set of the respective assignments that minimize a total penalty, comprising using mixed integer linear programming to minimize a sum of a dockout breach penalty and the respective assignment penalties based on constraints;
reassigning at least a portion of dockout times in the solution set to spread out the portion of the dockout times at the depot based on the dockout preferences; and
outputting the dockout times, as reassigned, for the routes.

10. The computer-implemented method of claim 9, wherein determining the respective assignment penalties further comprises:
determining a slack time for each of the routes;
determining a preferred dockout time for each of the routes;
determining whether the each of the respective assignments is feasible; and
determining the respective assignment penalties for the respective assignments based on the dockout preferences.

11. The computer-implemented method of claim 9, wherein the dockout preferences comprise shift-related dockout preferences and store-specified preferred dockout times.

12. The computer-implemented method of claim 11, wherein the shift-related dockout preferences comprise general dockout strategy and dockout strategy for special route types.

13. The computer-implemented method of claim 12, wherein the special route types comprise single-stop drop-hook routes.

14. The computer-implemented method of claim 9, wherein the constraints comprise:
assigning each of the routes to a single feasible time period of the time periods; and
preventing breaches in capacity from exceeding a maximum breach.

15. The computer-implemented method of claim 9, wherein reassigning at least the portion of the dockout times further comprises:
sub-partitioning the time periods for which there are multiple of the routes assigned in the solution set; and
greedily assigning routes to a feasible sub-partition based on a maximum average gap between the routes.

16. A non-transitory computer-readable medium storing computing instructions that, when executed on a processor, cause the processor to perform operations comprising:
obtaining inputs comprising dockout windows for routes from a depot, capacity information for the depot, and dockout preferences;
determining respective assignment penalties associated with respective assignments for feasible combinations of the routes and time periods within the dockout windows for the routes;
determining a solution set of the respective assignments that minimize a total penalty;
reassigning at least a portion of dockout times in the solution set to spread out the portion of the dockout times at the depot based on the dockout preferences, comprising:
sub-partitioning the time periods for which there are multiple of the routes assigned in the solution set; and
greedily assigning routes to a feasible sub-partition based on a maximum average gap between the routes; and
outputting the dockout times, as reassigned, for the routes.

17. The non-transitory computer-readable medium of claim 16, wherein determining the respective assignment penalties further comprises:
determining a slack time for each of the routes;
determining a preferred dockout time for each of the routes;
determining whether the each of the respective assignments is feasible; and
determining the respective assignment penalties for the respective assignments based on the dockout preferences.

18. The non-transitory computer-readable medium of claim 16, wherein:
the dockout preferences comprise shift-related dockout preferences and store-specified preferred dockout times; and
the shift-related dockout preferences comprise general dockout strategy and dockout strategy for special route types comprising single-stop drop-hook routes.

19. The non-transitory computer-readable medium of claim 16, wherein determining the solution set further comprises:
using mixed integer linear programming to minimize a sum of a dockout breach penalty and the respective assignment penalties based on constraints.

20. The non-transitory computer-readable medium of claim 19, wherein the constraints comprise:
assigning each of the routes to a single feasible time period of the time periods; and
preventing breaches in capacity from exceeding a maximum breach.
